(19) United States
(12) Patent Application Publication
(10) Pub. No.: US 2011/0235986 A1
(43) Pub. Date: Sep. 29, 2011

(54) OPTICAL FIBER DRAWER WITH CONNECTORIZED STUB CABLE

(75) Inventors: Jonathan R. Kaml, Shakopee, MN (US); Scott C. Kowalczyk, Savage, MN (US)

(73) Assignee: ADC Telecommunications, Inc., Eden Prairie, MN (US)

(21) Appl. No.: 13/069,932

(22) Filed: Mar. 23, 2011

Related U.S. Application Data
(60) Provisional application No. 61/317,158, filed on Mar. 24, 2010.

(51) Int. Cl. G02B 6/46

(52) U.S. Cl. 385/135

(57) ABSTRACT

A drawer panel includes a chassis housing defining a first cable port; and a drawer mounted within the chassis housing. The drawer is configured to slide between an open position and a closed position. A termination region is positioned on the drawer. At least a first stub cable routed to the first cable port of the chassis housing. The first stub cable is terminated by a ruggedized multi-fiber connector. The drawer provides cable management to accommodate a change in slack length when the drawer is open and shut. A fanout device is mounted to the chassis housing with a mounting bracket.

### CROSS-REFERENCE TO RELATED APPLICATIONS

This application claims the benefit of U.S. Provisional Application No. 61/317,158, filed Mar. 24, 2010, and titled “Optical Fiber Drawer with Connectorized Stub Cable,” the disclosure of which is hereby incorporated by reference herein.

### BACKGROUND

Optical networks are becoming prevalent in part because service providers want to deliver high bandwidth communication capabilities to customers. Fiber optic cables and/or copper cables can be used to interconnect pieces of telecommunications equipment. Cable management structures that provide cable management and cable terminations associated with the system are commonly mounted to telecommunication racks, within cabinets, or to other framework structures. Adaptation is a factor in the effectiveness of the overall management of cables and cable terminations. In general, conventional arrangements for managing cables and cable terminations can be improved.

### SUMMARY

Certain aspects of the disclosure relate to a cable management and termination arrangement that can be used in sliding drawer applications and rack enclosures therefore. Certain aspects of the disclosure relate to features that facilitate deployment of the drawer application. Other aspects relate to features that enhance cable management, ease of use, and scalability.

A variety of additional inventive aspects will be set forth in the description that follows. The inventive aspects can relate to individual features and to combinations of features. It is to be understood that both the forgoing general description and the following detailed description are exemplary and explanatory only and are not restrictive of the broad inventive concepts upon which the embodiments disclosed herein are based.

### BRIEF DESCRIPTION OF THE DRAWINGS

Referring to the drawing, wherein like numerals represent like parts throughout the several views:

FIG. 1 is a schematic diagram of an example rack enclosure mounted over an example handhole in accordance with aspects of the present disclosure;

FIGS. 2A-2C show an example handhole in accordance with aspects of the present disclosure;

FIGS. 3 and 3A show a first example implementation of an optical cable suitable for use as a feeder cable and/or a subscriber stub cable described herein;

FIG. 4 shows one example implementation of a second cable segment suitable for use as a feeder cable or a subscriber stub cable described herein.

FIG. 5 shows an example plug connector and an example receptacle connector that are configured to interface together in accordance with aspects of the disclosure;

FIGS. 6A and 6B show the ferrules of the plug and receptacle multi-fiber connectors of FIG. 5;

FIG. 7 is a top, front perspective view of a drawer panel with a drawer in a closed position within a chassis housing in accordance with aspects of the present disclosure;

FIG. 8 is a plan view of the drawer panel of FIG. 7 in accordance with aspects of the present disclosure;

FIG. 9 is a front elevational view of the drawer panel of FIG. 7 in accordance with aspects of the present disclosure;

FIG. 10 is a plan view of the drawer panel of FIG. 7 shown with a top of the chassis housing removed to show the interior of the chassis housing and drawer in accordance with aspects of the present disclosure;

FIG. 11 is a top, front perspective view of the drawer panel of FIG. 7 with the drawer in an open position relative to the chassis housing in accordance with aspects of the present disclosure;

FIG. 12 is a plan view of the drawer panel of FIG. 11 in accordance with aspects of the present disclosure;

FIG. 13 is a top, rear perspective view of the drawer panel of FIG. 11 in accordance with aspects of the present disclosure;

FIG. 14 is a detailed view of section I14 of FIG. 13, which shows a fanout device mounted to a bracket attached to the chassis housing, in accordance with aspects of the present disclosure;

FIG. 15 shows the mounting bracket of FIG. 14 without the fanout device in accordance with aspects of the present disclosure; and

FIG. 16 is a perspective view of the mounting bracket of FIG. 14 in accordance with aspects of the present disclosure.

### DETAILED DESCRIPTION

Reference will now be made in detail to exemplary aspects of the present disclosure that are illustrated in the accompanying drawings. Wherever possible, the same reference numbers will be used throughout the drawings to refer to the same or like parts.

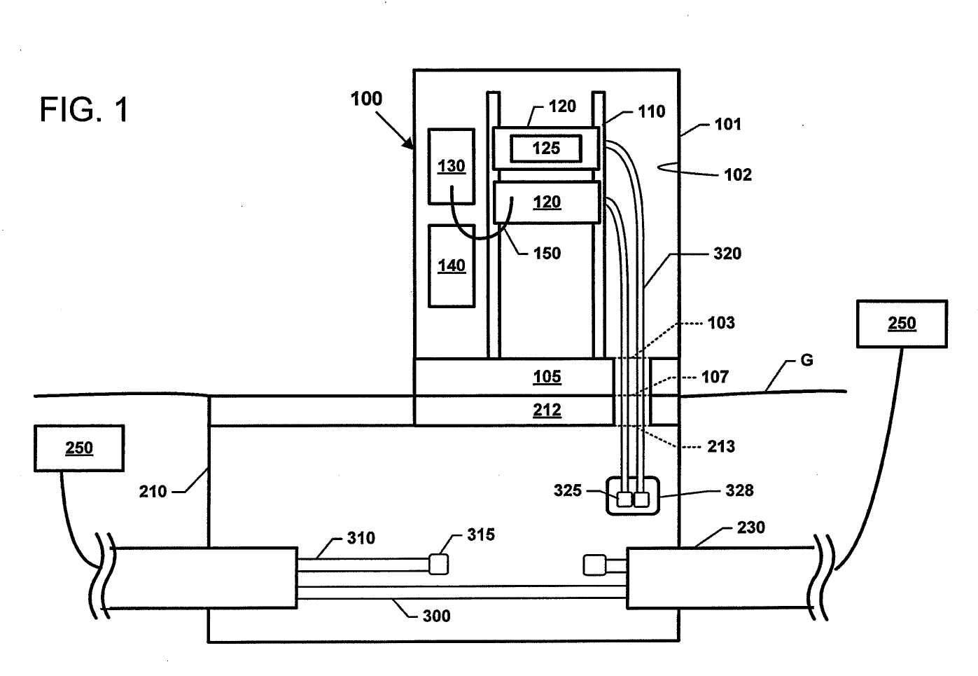

FIG. 1 is a schematic drawing of an example enclosure 100 mounted over an example handhole 200 positioned in the ground G beneath the enclosure 100. The enclosure 100 includes a housing 101 defining an interior 102. Active and/or passive telecommunications components can be positioned within the interior 102 of the housing 101. For example, a rack 110 configured to hold telecommunications equipment can be mounted within the enclosure housing 101.

In general, the rack 110 is configured to provide one or more termination regions 125 at which optical fibers can be optically coupled to other optical fibers. The rack 110 is configured to hold modular components 120 on which the termination regions 125 can be provided. In accordance with some aspects, the modular components 120 include patch panel modules on which the termination region 125 is provided. In accordance with other aspects, the modular components 120 include blades on which the termination regions 125 are provided. In accordance with other aspects, the modular components 120 include chassis drawers 120, which provide the termination region 125. In accordance with still other aspects, the rack 110 can be configured to hold any combination of the above modular components 120.

In accordance with certain aspects, telecommunications cables 320 can be routed into the enclosure 100 to the termination region 125. In some implementations, connectorized first ends of the cables 320 are connected to one side of the termination region 125. For example, in one implementation, a telecommunications cable 320 can be terminated by a multi-fiber connector (MFC), which can be plugged into an MFC adapter at the termination region 125. In another implementation, fibers of the telecommunications cable 320 can be separated, individually terminated by fiber optic connectors, and plugged into adapters at the termination region 125. In another implementation, fibers of the cable 320 can be optically coupled (e.g., spliced, connected, etc.) to intermediate fibers that are routed to the termination region 125.

Some example telecommunications cables (e.g., input cables) 320 may include one to forty-eight individual fibers. In different implementations, the telecommunications cables 320 can include two, eight, twelve, twenty-four, and forty-eight fibers. Other example telecommunications cables (e.g., output cables) 320 include a greater number of fibers (e.g., 48, 96, 144, 216, 288, 432, or 576 fibers). The telecommunications cables 320 are routed from the enclosure to other locations within a telecommunications network 100. In addition, the enclosure 100 can be designed to accommodate a range of alternative sizes and fiber counts and to support factory installation of pigtails, fanouts, and optical splitters.

In accordance with certain aspects, active telecommunications components (e.g., optical switches, etc.) 130 can be mounted within the enclosure housing 101. In some implementations, one or more active telecommunications components 130 can be optically coupled to the telecommunications cables 320 at the termination region 125 on the rack 110. For example, a telecommunications patch cord 150 can be routed between an active component 130 and the fiber termination region 125 of a modular component 120 mounted to the rack 110. The patch cord 150 includes one or more optical fibers that connect to optical fibers of the stub cables 320 via adapters mounted at the termination region. In one implementation, a patch cord 150 includes one or more buffered optical fibers.

In accordance with certain aspects, passive telecommunications components (e.g., fiber optic splitters, fiber optic adapters, splice trays, etc.) 140 also can be mounted within the enclosure housing 101. In some implementations, one or more passive telecommunications components 140 can be optically coupled to the telecommunications cables 320 at the termination region 125 on the rack 110. For example, a telecommunications patch cord 150 can be routed between a passive component 140 and the fiber termination region 125 of a modular component 120 mounted to the rack 110. The patch cord 150 includes one or more optical fibers that connect to optical fibers of the stub cables 320 via adapters mounted at the termination region.

In accordance with certain aspects of the disclosure, the telecommunications cables 320 are stubs cables that are precabled to telecommunications components located within the enclosure 100. For example, first ends of the stub cables 320 can be optically coupled to the fiber termination region 125 of one or more modular components 120. In some implementations, each modular component 120 can be associated with one or more stub cables 320. In other implementations, each stub cable 320 can be terminated at one or more modular components 120. In the example shown, one stub cable 320 extends from each modular component 120.

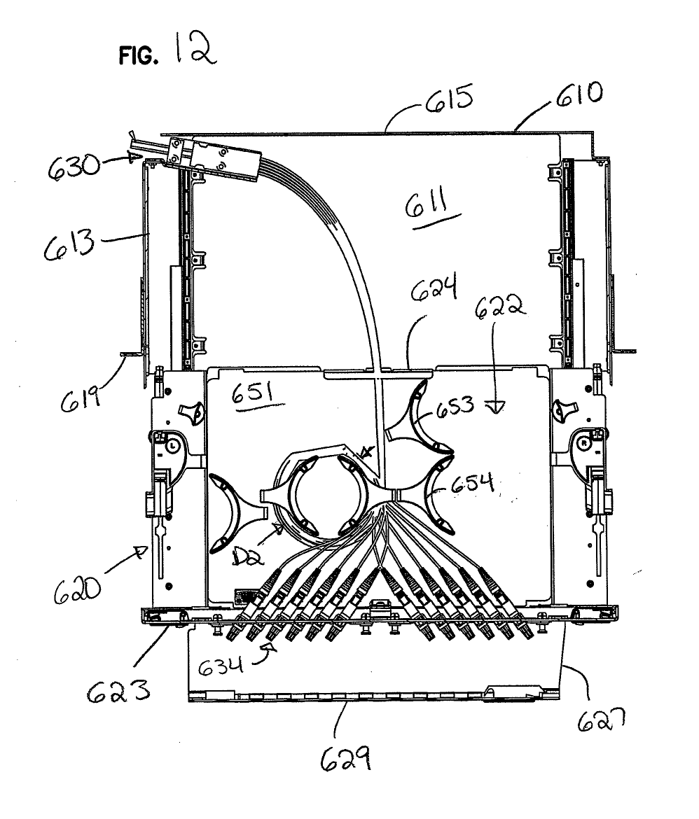

In some implementations, the first ends of the telecommunications cables 320 can be separated out (e.g., at a fanout device) into individual, connectorized optical fibers that are routed to the fiber termination regions 125. One example implementation of a fanout separating a first end of a telecommunications cable 320 will be discussed more herein with respect to FIGS. 11-16. In accordance with certain aspects, the stub cables 320 are optically coupled to the fiber termination regions 125 at a factory or other manufacturing site.

The other ends (also referred to as “stub ends”) of the stub cables 320 extend out from the enclosure housing 101 through a cable port 103. For example, in some implementations, the stub ends can extend about five to ten feet out from the enclosure body 101. In other implementations, however, the stub cables 320 can be longer or shorter. The stub end 309 of each cable 320 is terminated at a connector 325. In accordance with certain aspects, the connector 325 is a ruggedized connector that protects the fibers of the stub cable 320 from dirt, dust, and other environmental contaminants. In some implementations, the optical connector 325 of the stub cable 320 is a multi-fiber connector (MFC). One example MFC is described in more detail below. In accordance with other aspects, however, each fiber of the stub cable 320 can be separately connectorized.

In some implementations, the connectorized ends 325 of two or more stub cables 320 can be organized at a manager 328. In some implementations, the manager 328 includes a body that is configured to retain each of the optical connectors 325 of the stub cables 320. In other implementations, the manger 328 includes a body that is configured to retain each of the stub cables 320 at a point adjacent the connectors 325. In one implementation, the manager 328 includes a panel from which fingers project to retain the connectors 325 or the stub cables 320. In another implementation, the manager 328 includes a housing defining receptacles configured to receive the connectors 325. In another implementation, the manager 328 includes a flexible band that can be secured around a plurality of the connectors 325.

The stub cables 320 exit the enclosure housing 101 through the cable port 103 and enter the handhole 200 through a handhole cable port 213. The handhole 200 includes a container structure 210 that is buried below ground G. The container structure 210 includes at least one support panel or platform 212 on which the enclosure 100 can be mounted. The support platform 212 is mounted to a top of the container 210, e.g., as described in more detail herein. The panel 212 defines the cable port 213, which aligns with the cable port 103 of the enclosure body 101.

For example, in some implementations, the enclosure 100 can be mounted directly to the support platform 212. In other implementations, an access module 105 can be secured to the support platform 212 and the enclosure 100 can be mounted to the access module 105. The access module 105 can define a cable port 107 through which the telecommunications cables 320 can pass between the enclosure 100 and the handhole 200.

At least one underground conduit 230 is routed into an interior of the container structure 210. The conduits 230 are configured to route telecommunications cables 300 to different locations in a telecommunications network. In some implementations, a single conduit 230 passes through the handhole container 210. In other implementations, multiple conduits 230 can pass through the handhole container 210. At least one of the conduits 230 provides an access point at which one or more cables 300 can be routed from the conduit 230 to the enclosure 100. In still other implementations, one or more conduits 230 terminate at the container interior.

During deployment of the enclosure 100, the stub ends of the cables 320 are routed into the handhole container 210 through the cable port 213. Within the handhole container 210, the stub cables 320 can be optically coupled to one or more select cables 310 of the telecommunications cables 300 routed through the conduits 230. Accordingly, the select cables 310 are optically coupled to the active or passive components 130, 140 mounted within the enclosure when a patch cord 150 connects the components 130, 140 with the select cables 310.

In some implementations, the select cables 310 can be terminated at one or more optical connector 315, which can be interfaced (e.g., directly or through an adapter) to the optical connectors 325 of the stub cables 320 to connect telecommunications components within the enclosure 100 to other points 250 in the telecommunications network 100 (above or below ground). For example, in one implementation, the optical connector(s) 315 of the conduit cables 310 and the optical connector(s) 325 of the stub cables 320 are both MFCs.

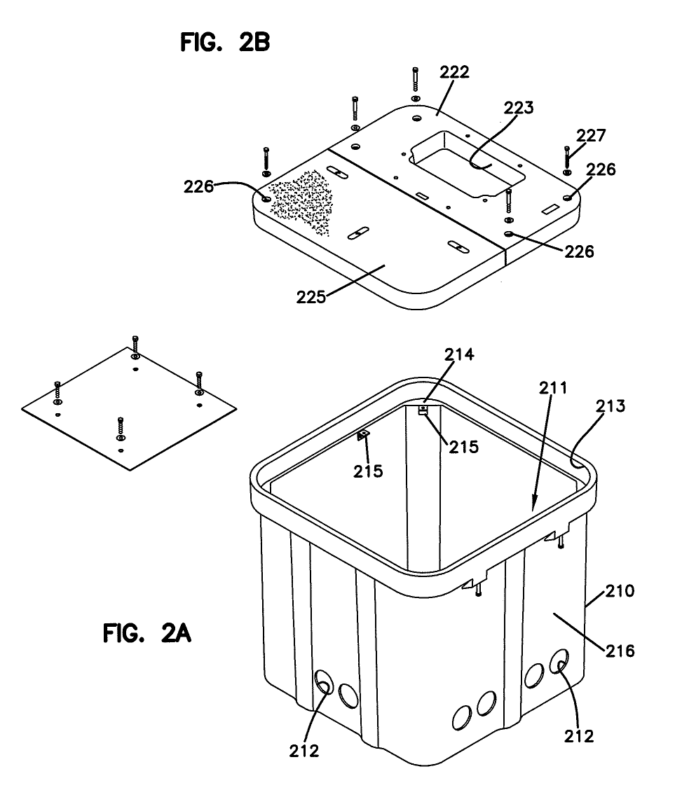

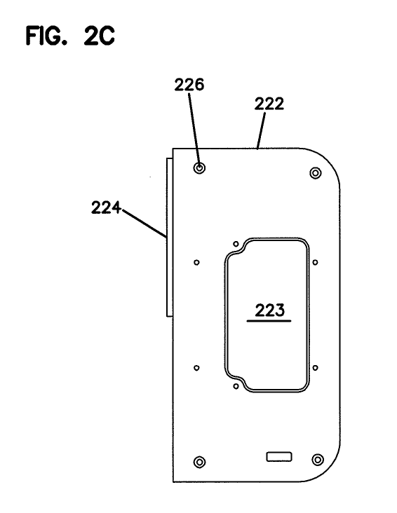

An example handhole 200 is shown in FIGS. 2A-2C. FIG. 2A is a top, perspective view of an example handhole container 210 having an open top 213 leading to an interior 211. Through holes 212 are defined within the side walls 216 of the container 210. The through holes 212 are sized and shaped to enable conduits 230 to enter and exit the container interior 211. In the example shown, at least one side wall 216 defines two through holes 212 and at least one side wall 216 defines four through holes 212. In some implementations, opposing side walls 216 can define a like number of through holes 212 to enable conduits 230 to pass fully through the container 210. In other implementations, opposing side walls 216 can each define a different number of through holes 212 (including zero).

The container 210 defines shoulders 214 within the interior 211 just below the open top 213. In the example shown, the shoulders 214 are provided at the corners of the container 210. In other example implementations, however, the shoulders 214 also can be provided along the sides of the container 210. The support platform 222 is configured to seat on the shoulders 214 at the open top 213 of the container 210. Brackets 215 or other supporting hardware can be provided on the container 210 for securing the support platform 222 to the container 210.

One example support panel 222 is shown in FIG. 2B. The support panel 222 defines a cable port 223 that provides access to the interior 211 of the container 210. The support panel 222 also defines through openings 426 through which fasteners (e.g., screws, bolts, rivets, etc.) 227 can extend to secure the support panel 222 to the brackets 215 within the container 210. Typically, the support platform 222 extends over only a portion of the open top 213 of the container 210. Accordingly, one or more brackets 215 can be positioned along the sides of the open top 213 of the container 210 (see FIG. 2A).

The handhole 200 also includes one or more access panels 225 that cover the remainder of the open top 213 to provide selective access to the interior 211 of the container 210. The access panel 225 is configured to seat on the support members 214 at the open top 213 of the container 210. In one implementation, the support platform 222 includes a step 424 protruding outwardly to provide further support for the access panel 225 (see FIG. 2C). In one implementation, the access panel 225 also defines at least one through opening 426 through which a fastener can extend to secure the access panel 225 to the top 213 of the container 210.

Typically, the fastener that secures the access panel 225 to the container 210 is removable. Accordingly, the access panel 225 can be moved to enable a technician to access the interior 211 of the container 210. In one implementation, the access panel 225 is configured to be lifted up and fully removed from the open top 213 of the container 210 when access to the container interior 211 is desired. In another implementation, the access panel 225 is configured to be pivoted upwards to provide access to the container interior 211.

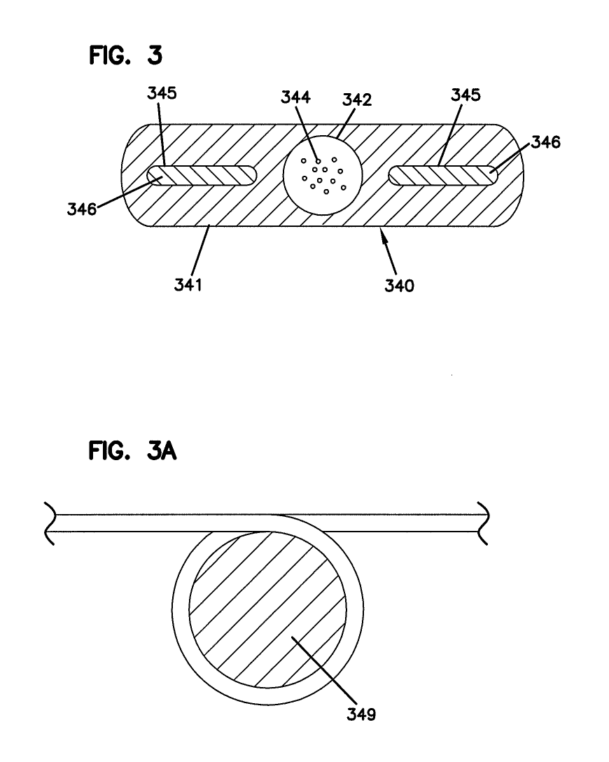

FIGS. 3 and 3A show a first example implementation of an optical cable 340 suitable for use as a feeder cable and/or a subscriber stub cable 320 described herein. The first example cable 340 includes an outer jacket 341 defining at least a first passage 342 for containing at least one optical fiber 344 and at least a second passage 345 for containing at least one strength member 346. In one implementation, the outer jacket 341 includes a central passage 342 for containing optical fibers 344 and two passages 345 on opposite sides of the central passage 344 for containing strength members 346. In other implementations, the first example cable 340 can include greater or fewer strength members 346 enclosed within the jacket 341.

In accordance with some aspects, the first example cable 340 has an elongated transverse cross-sectional profile (e.g., a flattened cross-sectional profile, an oblong cross-sectional profile, an obround cross-sectional profile, etc.) defined by the outer jacket 341. The major axis and the minor axis of the cross-sectional profile intersect perpendicularly at a lengthwise axis of the cable 340. The construction of the first example cable 340 allows the cable 340 to be bent more easily along a plane that coincides with the minor axis than along a plane that coincides with the major axis. Such a construction allows the first example cable 340 to be readily used for applications in which drop cables are normally used and also allows the first example cable 340 to be wrapped around a cable storage spool having a relatively small diameter without damaging the example cable 340. Other implementations of the first example cable 340 can have round, oval, or other transverse cross-sectional profiles, however.

In accordance with some aspects, the outer jacket 341 can be shaped through an extrusion process and can be made by any number of different types of polymeric materials. In certain embodiments, the outer jacket 341 can have a construction the resists post-extrusion shrinkage of the outer jacket 341. For example, the outer jacket 341 can include a shrinkage reduction material disposed within a polymeric base material (e.g., polyethylene). U.S. Pat. No. 7,379,642, which is hereby incorporated by reference in its entirety, describes an exemplary use of shrinkage reduction material within the base material of a fiber optic cable jacket 341.

In some implementations, the first passage 342 of the outer jacket 341 is sized to receive one or more of the bend insensitive fibers 344. The bend insensitive fibers 344 are preferably unbuffered and in certain embodiments have outer diameters in the range of 230-270 μm. In one implementation, the first passage 342 is sized to receive at least twelve of the bend insensitive fibers 344. When the fibers 344 are positioned within the first passage 342, it is preferred for the fibers 344 to occupy less than 60% of the total transverse cross-sectional area defined by the first passage 342. In some implementations, structures such water-swellable fibers, water-swellable tape, or water-swellable yarn can be provided within the passage 342 to prevent water from migrating along the first passage 342. In other implementations, water-blocking gel may be provided within the first passage 342.

In accordance with some implementations, the strength members 346 of the first example cable 340 have a transverse cross-sectional profile that matches the transverse cross-sectional profile of the second passage 345. In one implementation, each strength members 346 has a width that is greater than a thickness of the strength member 346. In certain implementations, the strength members 346 are bonded to the outer jacket 341. For example, the bonding between the strength members 346 and the outer jacket 341 can be chemical bonding or thermal bonding.

In accordance with some aspects, each strength members 346 has a construction that is highly flexible and highly strong in tension. For example, in certain implementations, the strength members 346 provide the vast majority of the tensile load capacity of the first example cable 340. In certain implementations, each strength member 346 also has a flexibility that allows the strength member 346 to be wrapped at least 360 degrees around a mandrel 349 (see FIG. 3A) having a 10 millimeter outer diameter for one hour without undergoing/experiencing meaningful deterioration/degradation of the tensile strength properties of the strength member 346.

In certain embodiments, the strength member 346 is formed by a generally flat layer of reinforcing elements (e.g., fibers or yarns such as aramid fibers or yarns) embedded or otherwise integrated within a binder to form a flat reinforcing structure (e.g., a structure such as a sheet-like structure, a film-like structure, or a tape-like structure). In one example embodiment, the binder is a polymeric material such ethylene acetate acrylite (e.g., UV-cured, etc.), silicon (e.g., RTV, etc.), polyester films (e.g., biaxially oriented polyethylene terephthalate polyester film, etc.), and polyisobutylene. In other example instances, the binder may be a matrix material, an adhesive material, a finish material, or another type of material that binds, couples or otherwise mechanically links together reinforcing elements.

In other embodiments, the strength member 346 can have a glass reinforced polymer (GRP) construction. The glass reinforced polymer can include a polymer base material reinforced by a plurality of glass fibers such as E-glass, S-glass or other types of glass fiber. The polymer used in the glass reinforced polymer is preferably relatively soft and flexible after curing. For example, in one embodiment, the polymer has a Shore A hardness less than 50 after curing. In other embodiments, the polymer has a Shore A hardness less than 46 after curing. In certain other embodiments, the polymer has a Shore A hardness in the range of about 34-46.

Additional details regarding the example first cable segment 110 can be found in U.S. application Ser. No. 12/607,748, filed Oct. 28, 2009, published as US 2010/0278493, and titled “Flat Drop Cable,” the disclosure of which is hereby incorporated herein by reference in its entirety. Of course, other types of fiber optic cables having different tensile strength and flexibility characteristics can be used as the first cable segment.

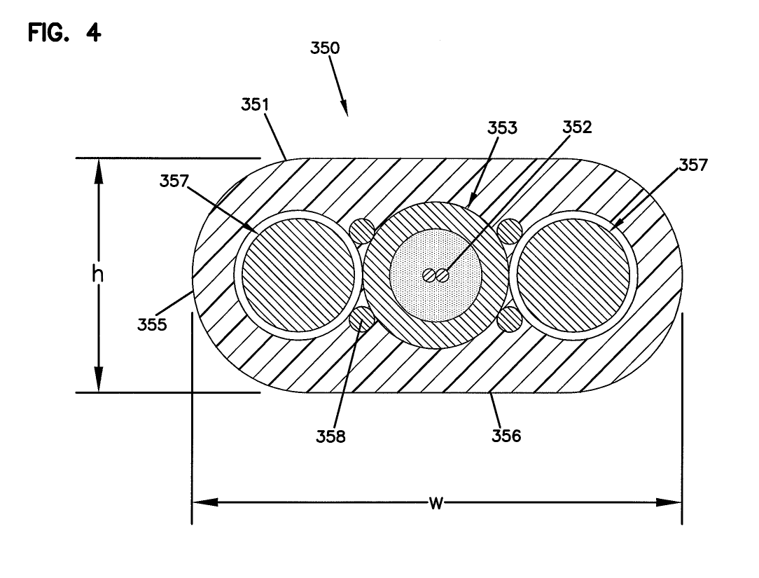

FIG. 4 shows one example implementation of a second cable segment 350 suitable for use as a feeder cable or a subscriber stub cable 320 described herein. The second example cable 350 includes a cable jacket 351 enclosing at least one optical fiber 352. In one implementation, the optical fiber 352 is loosely received within a buffer tube 353. Preferably, buffer tube 353 includes at least one waterblocking substance, for example, a gel, grease, and/or a superabsorbent material. In some implementations, the second example cable 350 has a generally flat configuration. For example, the jacket 351 can define generally arcuate sections 355 and generally flat-sided sections 356. Other implementations of the second example cable 350, however, can have round, oval, or other transverse cross-sectional profiles.

The second example cable 350 also includes at least one strength component 357. In the example shown in FIG. 4, the optical transmission component 352 is disposed between two strength components 357. In other implementations, however, greater or fewer strength components 357 can be used. In accordance with certain aspects, the strength components 357 have both tensile and anti-buckling characteristics. In some implementations, the strength components 357 are solid, rod-like members formed of dielectric materials. For example, in one implementation, a strength component 357 includes glass filaments impregnated and bonded together with a resin to define a single unit having a tensile strength rating of about 500 Newtons @ 0.5% strain.

In some implementations, the second example cable 350 can include one or more tensile strength members 358 (e.g., a group of fiberglass strands). In other implementations, however, the strength components 357 provide the tensile strength of the second example cable 350. Additional details regarding the example second example cable 350 can be found in U.S. Pat. No. 6,542,674, titled “Fiber Optic Cables with Strength Members,” and issued Apr. 1, 2003 to Corning Cable Systems, LLC, the disclosure of which is hereby incorporated by reference herein. Of course, other types of fiber optic cables having different tensile strength and flexibility characteristics can be used as the second cable segment.

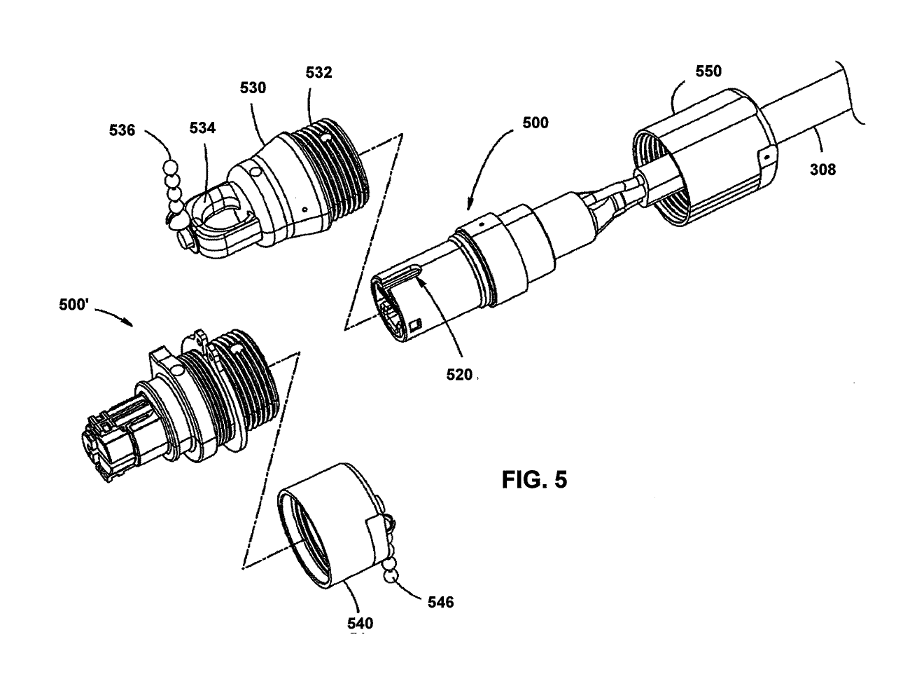

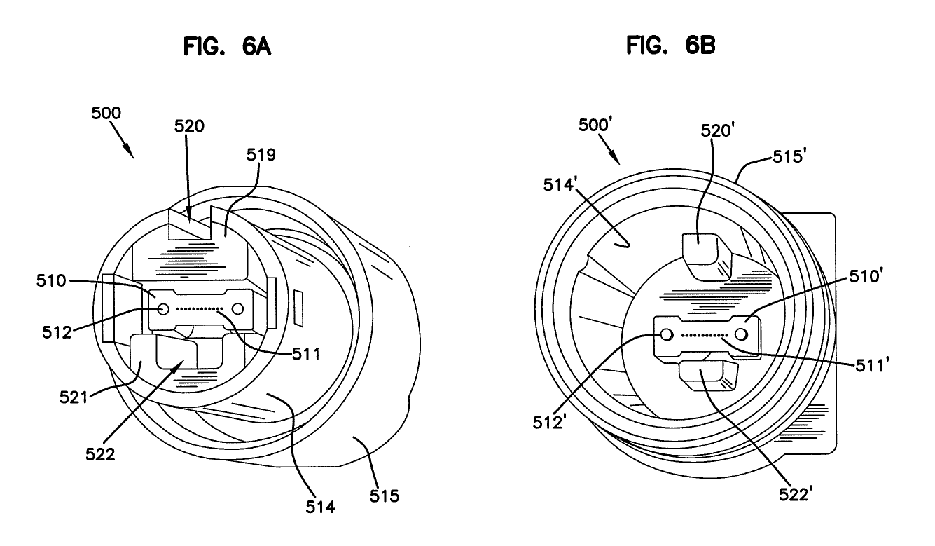

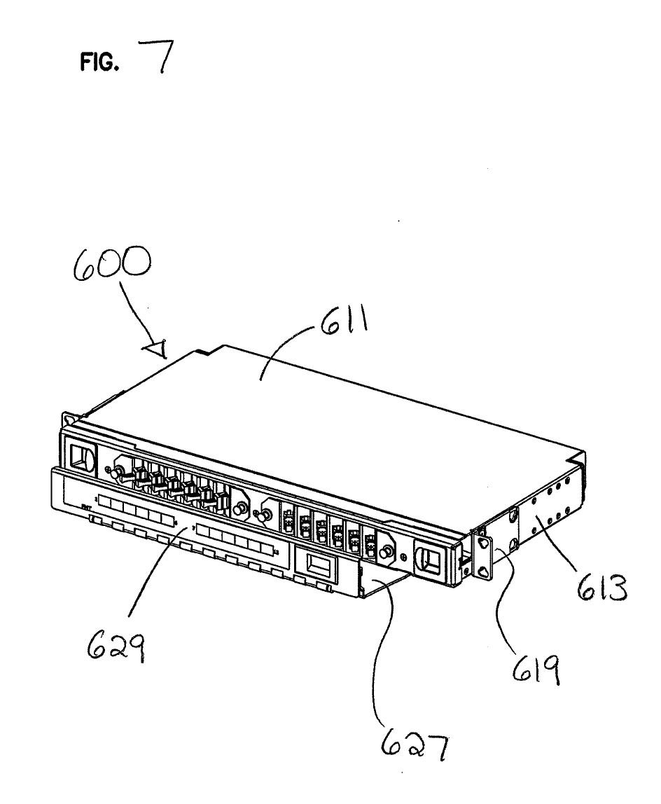

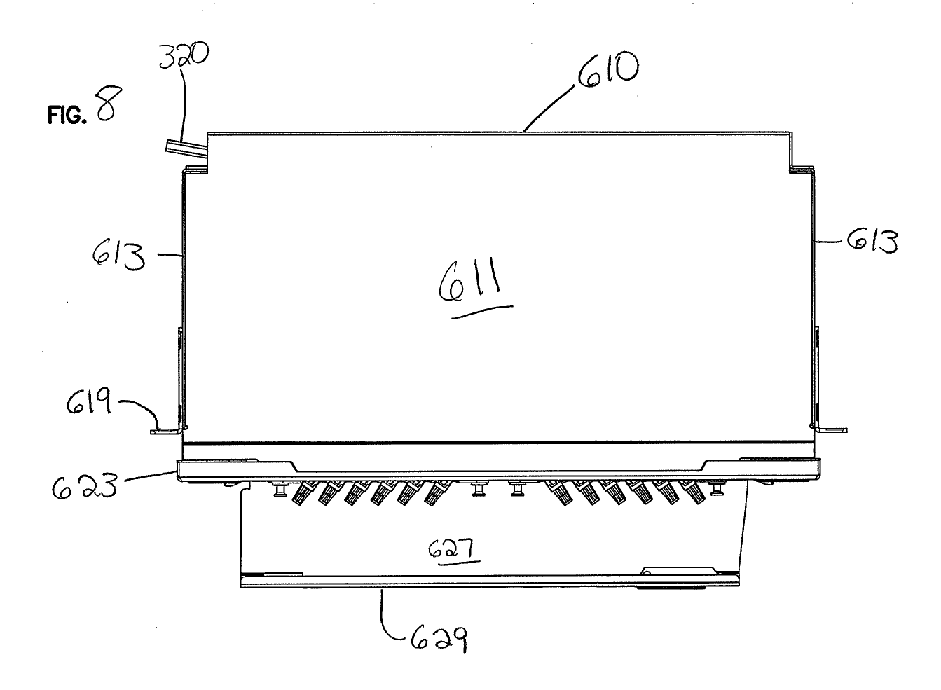

FIGS. 5, 6A, and 6B provide example connectors suitable for terminating the stub ends 309 of the subscriber cables 320, the feeder cables, and/or the ends of the cables 320 passing through the conduits 230. The interface end of a first example connector 500 is shown in FIG. 6A and the interface end of a second example connector 500′ is shown in FIG. 6B. In accordance with some aspects, the first example connector 500 is sized and shaped to couple to the second example connector 500′ without an adapter. For example, the first example connector 500 can define a plug and the second example connector 500′ can define a receptacle that is configured to receive the plug 500.

FIG. 5 shows the plug 500 disengaged from the receptacle 500′. A threaded coupling nut 550 on the plug 500 is operable for securing the plug 500 to the receptacle 500′ upon engagement. As shown in FIG. 6A, the connector plug 500 includes a ferrule 510 at which one or more optical fibers 511 are terminated. As shown in FIG. 6B, the connector receptacle 500′ also includes a ferrule 510′ at which one or more optical fibers 511′ are terminated. In some implementations, the plug 500 and receptacle 500′ are operable for aligning and maintaining the optical fibers of each in opposing relation for transmitting an optical signal. For example, the plug 500 and the receptacle 500′ may be threadably coupled together. In accordance with other aspects, however, both the subscriber cables 308 and the conduit cables 320 can be terminated with the same type of connector 500, 500′ and can be interfaced at an adapter.

In some implementations, the plug ferrule 510 terminates multiple (e.g., two, eight, twelve, sixteen, twenty-four, forty-eight, seventy-two, etc.) optical fibers 511. In the example shown, the ferrule 510 terminates twelve optical fibers 511. The plug ferrule 510 defines keying openings 512 at either side of the optical fibers 511. The ferrule 510 is enclosed within a shroud 514 that defines keying and latching features. The shroud 514 and ferrule 510 extend forwardly of a connector base 515. The shroud 514 extends beyond the ferrule 510. The shroud 514 defines a first keying channel 520 and a second keying channel 522 above and below the ferrule 510, respectively. Strength members of the cables (e.g., feeder stub cable 300 and subscriber stub cable 308) also may be anchored to the connector plug 500. For example, strength members of the cables may be crimped to a portion of the connector plug 500.

In some implementations, the receptacle ferrule 510′ terminates multiple (e.g., two, eight, twelve, sixteen, twenty-four, forty-eight, seventy-two, etc.) optical fibers 511. In the example shown, the receptacle ferrule 510′ terminates twelve optical fibers 511′. The receptacle ferrule 510′ is enclosed within a connector body 515′ defines a cavity 514′ that is sized and shaped to receive the shroud 514 of the plug 500. The connector base 515′ is configured to surround the shroud 514. In some embodiments, the connector base 515′ latches, screws, or otherwise secures to the shroud 514 to retain the plug 500 and the receptacle 500′ in a mated configuration.

The receptacle ferrule 510′ defines keying projections 512′ at either side of the optical fibers 511′. The projections 512′ are configured to be inserted into the keying openings 512 of the plug ferrule 510 to facilitate alignment of the ferrules 510, 510′. In addition, a first keying projection 520′ and a second keying projection 522′ are positioned within the cavity 514′ above and below the ferrule 510′, respectively. In some implementations, the first and second keying projections 520′, 522′ have different shapes and/or sizes to facilitate finding the correct orientation of the plug and receptacle. Strength members of the cables (e.g., feeder stub cable 300 and subscriber stub cable 308) also may be anchored to the connector receptacle 500′. For example, strength members of the cables may be crimped to a portion of the connector receptacle 500′.

The rugged housings of both the receptacle and plug provide improved sealing and increased mechanical strength against pulling forces as compared to conventional optical connections. In some implementations, the connectors 500, 500′ include an environmental seal when interfaced together to protect the ferrules 511, 511′ from dust, dirt, or other contaminants. In some implementations, environmental sealing structures can be mounted to the connectors 500, 500′ to protect the ferrules 511, 511′ prior to deployment of the FDH 200 or prior to connection of the connectors 500, 500′.

For example, a protective pulling cap 530 is shown exploded from the plug 500 in FIG. 5. The pulling cap 530 defines a threaded portion 532 at its rearward end and a pulling loop 534 at its forward end. The pulling cap 530 provides protection of the optical connector of the plug 500 during shipping and deployment, and until engagement of the plug 500 with the receptacle 500′. The pulling cap 530 may be secured to the cable using a tether 536 so that the pulling cap 530 may be reused if the plug 500 is later disengaged from the receptacle 500′. The coupling nut 550 also may secure the pulling cap 530 to the plug 500 during shipping and deployment of the corresponding cable.

A protective dust cap 540 is shown exploded from the receptacle 500′ in FIG. 5. The receptacle 500′ may be covered and sealed with a threaded protective dust cap 540 during shipping and deployment. The dust cap 540 is removed prior to inserting the plug 500 into the receptacle 500′. The dust cap 540 may be secured to the receptacle 500′ using a tether 546. At the end of the receptacle 500′ opposite the dust cap 540, a pre-formed, elastomeric seal boot (not shown) may provide protection for the receptacle 500′ from the environment within the connection terminal. The protective boot also may provide a sealing function. The protective boot allows the assembly to be installed in a breathable connection terminal or similar enclosure, and may be unnecessary in the event the receptacle 500′ is otherwise reliably sealed from the environment.

Additional details regarding the example connector plug 500 and receptacle 500′ can be found in U.S. Pat. No. 7,264,402 to Theuerkorn et al., issued Sep. 4, 2007, and titled “Multi-fiber optic receptacle and plug assembly,” the disclosure of which is hereby incorporated by reference herein.

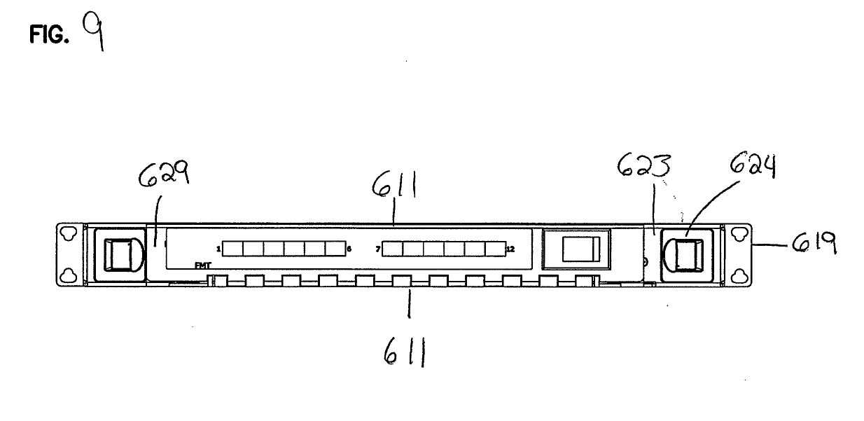

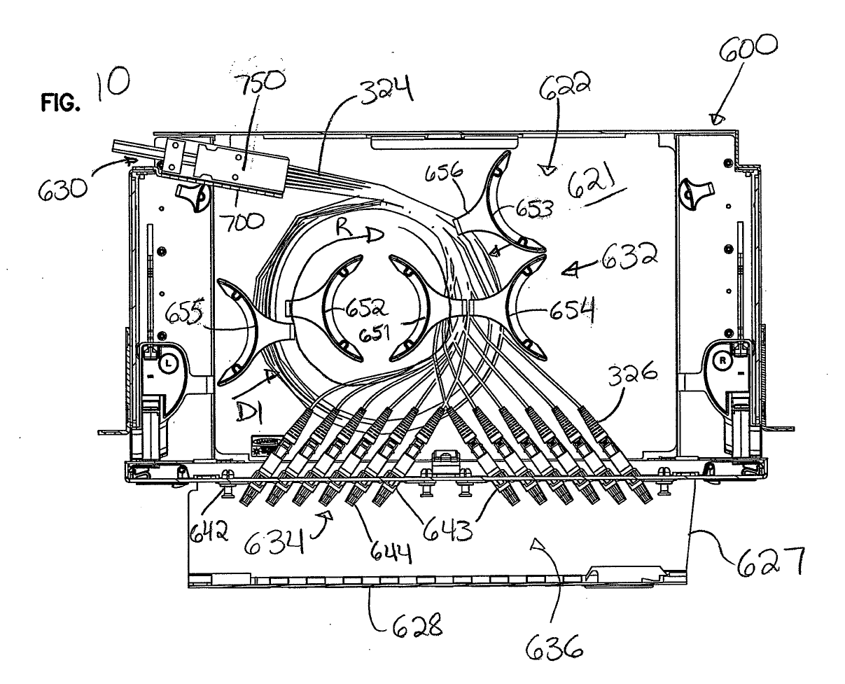

FIGS. 7-16 show an example drawer panel 600 suitable for mounting to a telecommunications equipment rack 110 (see FIG. 1) as a modular component 120. The example drawer panel 600 provides one or more termination regions 625 at which optical fibers can be connected to other optical fibers. For example, the stub cables 320 can connect to patch cords 150 (FIG. 1) at the termination region 625. In other implementations, the stub cables 320 can connector to other optical fibers managed within the enclosure 100. The drawer panel 600 also provides cable/fiber management regions for managing the stub cables 320, patch cords 150, and optical fibers thereof.

The example drawer panel 600 includes a chassis body 610 defining an interior 612 within which a drawer 620 can be located (see FIG. 11). In general, the drawer 620 holds one or more telecommunications components (e.g., cables, terminations, storage spools, couplers, etc.). In some implementations, the drawer 620 defines an interior 622 in which optical fibers 324 of the stub cables 320 can be managed and routed to the termination region 625. For example, cable routing members (e.g., spools, tabs, bend radius limiters, etc.) 634 can be located within the drawer interior 622. Examples of other terminations, cable management components, and/or distribution structures that can be provided within the drawer interior and/or chassis include attenuators, couplers, switches, wave divisions multiplexers, splitters, combiners, or splices.

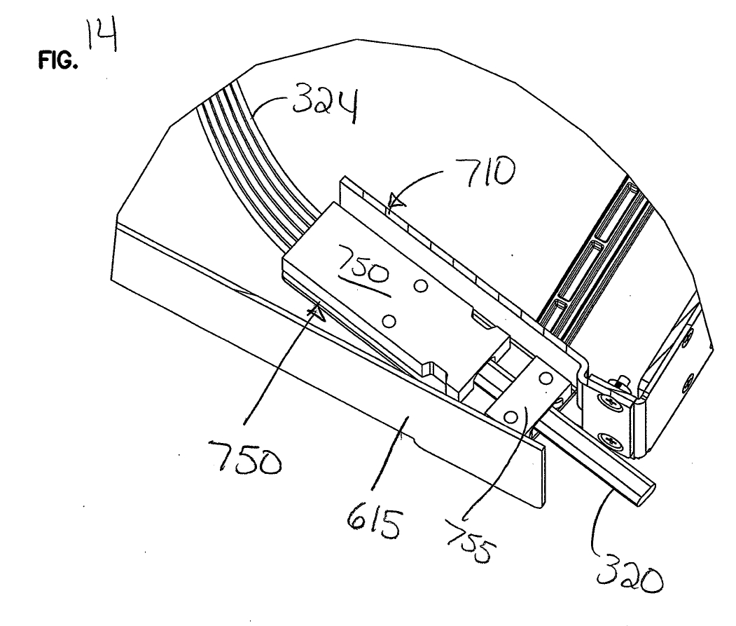

In general, the drawer 620 is moveably mounted within the chassis body 610. For example, the drawer 620 can be configured to slide within the chassis body 610. When the drawer 620 is configured to slide relative to the chassis housing 610, the drawer panel 600 is horizontally mounted, for example, to the telecommunications rack 110 (schematically illustrated in FIG. 1) or other framework. In some implementations, the chassis housing 610 includes slide structure (e.g., channels; see FIGS. 11 and 13) that receives edges of the drawer 620. The drawer 620 slides within the slide structure between a closed position (see FIGS. 7-10) and an open position (see FIGS. 11-13) to provide access to the telecommunications components contained within the drawer 620.

As shown in FIGS. 7-9, the chassis housing 610 encloses and protects the contents of the drawer 620. The chassis body 610 includes opposing side walls 613 extending between opposing top and bottom walls 611 to define a chassis interior 612 (FIG. 11). In one implementation, the chassis body 610 has a rear wall 615 and an open front 617 (FIG. 11). In another implementation, the chassis body 610 defines an open rear and an open front. Mounting members 619 are attached to the chassis body 610 to facilitate securing the chassis body 610 to the rack 110. In the example shown, the mounting members 619 include L-shaped brackets having a first leg fastened to an exterior of the chassis body 610 and a second leg configured to fasten to the rack 110 (FIGS. 7-10). For example, screws, rivets, bolts, or other fasteners can be inserted through openings defined in the brackets 619. In other implementations, other types of mounting hardware (e.g., clamps, slides, snap-together flanges, etc.) can be provided.

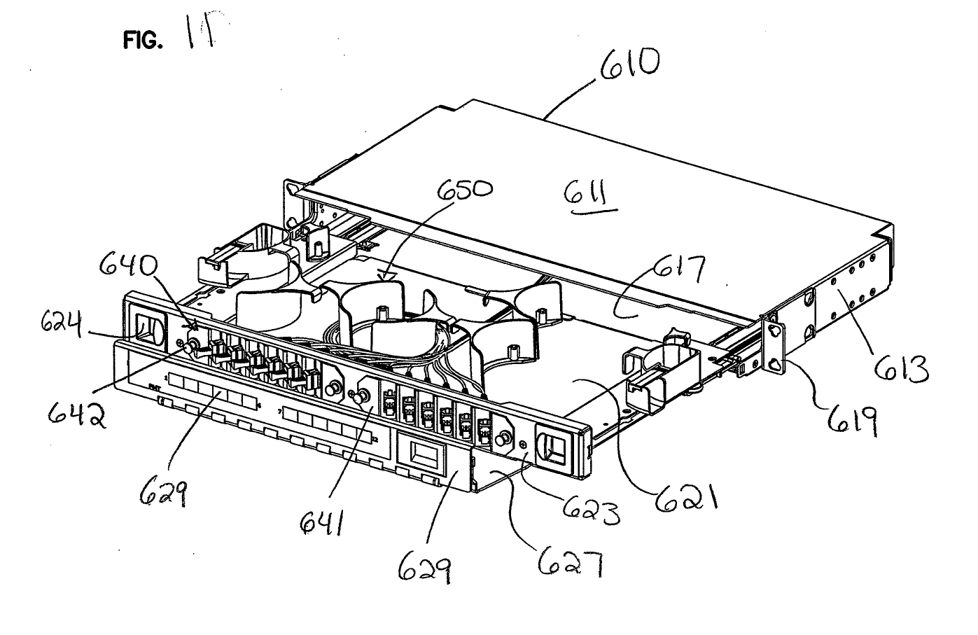

The chassis housing 610 can define a cable port 630 through which one or more stub cables 320 (or corresponding optical fibers) can be routed into the drawer panel 600. In certain implementations, one or more fanout devices 750 can be mounted to the chassis housing 612 at the cable port 630 to separate out individual fibers from the stub cables 320 (see FIG. 10). In general, the fanout devices 750 are mounted to the chassis housing 610 so that the drawer 620 moves relative to the fanout devices 750. In some implementations, the fanout devices 750 can be mounted to a rear of the chassis housing interior 612. In other implementations, the fanout devices 750 can be mounted to an exterior of the chassis housing 610. Additional details about the mounting the fanout devices 750 to the chassis housing are discussed herein with respect to FIGS. 13-16.

As shown in FIGS. 10-13, the drawer 620 includes a base 621 and a face member 623 attached to the base 621. In the illustrated embodiment, an interior 622 (FIG. 10) of the drawer 620 is generally defined by the perimeter of the base 621. In one implementation, the drawer 620 has open sides and an open rear. In another implementation, the drawer 620 can include side walls and/or a rear wall that define the drawer interior 622. The face member 623 defines handles 624. In some implementations, the drawer 620 also includes a storage trough 627 extending forwardly of the face member 623. The storage trough 627 can include a retaining flange 628 extending at least partially in front of the face member 623 (see FIG. 11). Labels or other indicia for the drawer panel 600 can be provided on the retaining flange 628.

In accordance with some aspects, the interior 622 of the drawer 620 defines a first management region 632, the face member 623 defines a fiber termination region 634, and the trough 627 defines a second management region 636. Fibers 324 of stub cables 320 routed into the drawer panel 600 through the cable port 630. Connectorized ends 326 of the fibers 324 are plugged into fiber optic adapters 643 at the termination region 634. Dust caps 644 can be provided at unused adapter ports to protect the adapters 643 and to protect the connectors terminating any fibers inserted into corresponding ports (see FIGS. 10-11).

In some implementations, the fiber optic adapters 643 are individually plugged into openings provided on the face member 623. In other implementations, the fiber optic adapters 643 are mounted to termination plates 641 that are configured to mount to the face member 623. For example, the termination plates 641 can mount to the face member 623 using fasteners (e.g., screws, push tabs, etc.) 642 (e.g., see fastener 642 of FIG. 10). In some implementations, the adapters 643 are arranged at an angle relative to the terminal plate 641 (e.g., see FIG. 10).

In one implementation, a single termination plate 641 is mounted to the face member 623. In another implementation, multiple termination plates 641 are mounted to the face member 623. In the example shown in FIG. 11, two termination plates 641 are mounted to the face member 623 side-by-side. In some such implementations, the adapters 643 on one termination plate 641 are angled in one direction and the adapters 643 on the other termination plate 641 are angled in a different direction (see FIG. 10). In other implementations, the termination plates 641 can be mounted in multiple rows and/or columns.

Slack fiber length of the fibers 324 is stored and managed at the first management region 632 within the drawer interior 622. For example, the first management region 632 can include one or more management members 650, such as bend radius limiters, spool (full or partial), tabs, or other fiber routing tools. The management members 650 of the first management region 632 define a routing path R through which the optical fibers 324 are directed to route the fibers 324 from the cable port 630 to the termination region 634. The configuration of the first management region 632 is discussed in more detail herein.

The termination region 634 enables the optical fibers 324 of the stub cables 320 to be optically coupled to second optical fibers (e.g., of a patch cord 150 of FIG. 1). In some implementations, the second optical fibers are routed from the drawer panel 600 to other modular components 120 on the rack 110 or to other internal components within the enclosure 100 (e.g., see FIG. 1). The second optical fibers are managed at the trough 627 on the drawer 620. The trough 627 and retaining flange 628 inhibits the second fibers from spilling over the front of lower drawer panels 600 or other modular components 120 mounted on the rack 110. In one implementation, the retaining flange 628 is configured to pivot or otherwise move relative to the face plate 623 to provide access to the termination region 634.

The drawer 620 is configured to be slid out of the chassis housing 610 to an open position and into the chassis housing 610 to a closed position. Accordingly, the drawer 620 is moved relative to any fanout devices 750 mounted to the cable ports 630. In accordance with some aspects, the routing path R is configured to accommodate the slack storage length as the drawer 620 is moved between the open and closed positions. For example, in some implementations, the management members 650 include one or more spools (or other bend radius limiters) that define an inner perimeter of the path R and one or more spools (or other bend radius limiters) that define an outer perimeter of the path R. The fibers 324 are free to move between the inner and outer perimeters of the path R as the drawer 620 is moved relative to the chassis housing 610.

In some implementations, the path R has a circular or elliptical inner perimeter. In the example shown, the inner perimeter of the path R is define by a first partial spool 651 and a second partial spool 652 positioned within the drawer interior 622. In another implementation, the inner perimeter of the path R can be defined by a full spool. In other implementations, additional spools or other management members can be positioned within the drawer interior 622 to form the inner perimeter of the path R.

In the example shown, the outer perimeter of the path R is formed by additional partial spools 653-655. A third partial spool 653 is positioned within the drawer 620 to facilitate routing the fibers 324 from the cable port 630 to the routing path R. A fourth partial spool 654 is positioned adjacent the first partial spool 651 to define a first channel through which the fibers 324 can pass. A fifth partial spool 654 is positioned adjacent the second spool 652 to define a second channel through which the fibers 324 can pass. In other implementations, the routing path R can be formed by a greater or lesser number of spools pairs. In certain implementations, one or more of the spools 651-655 include tabs 656 that extend outwardly from the spools to facilitate retaining the fibers 324 within the path R.

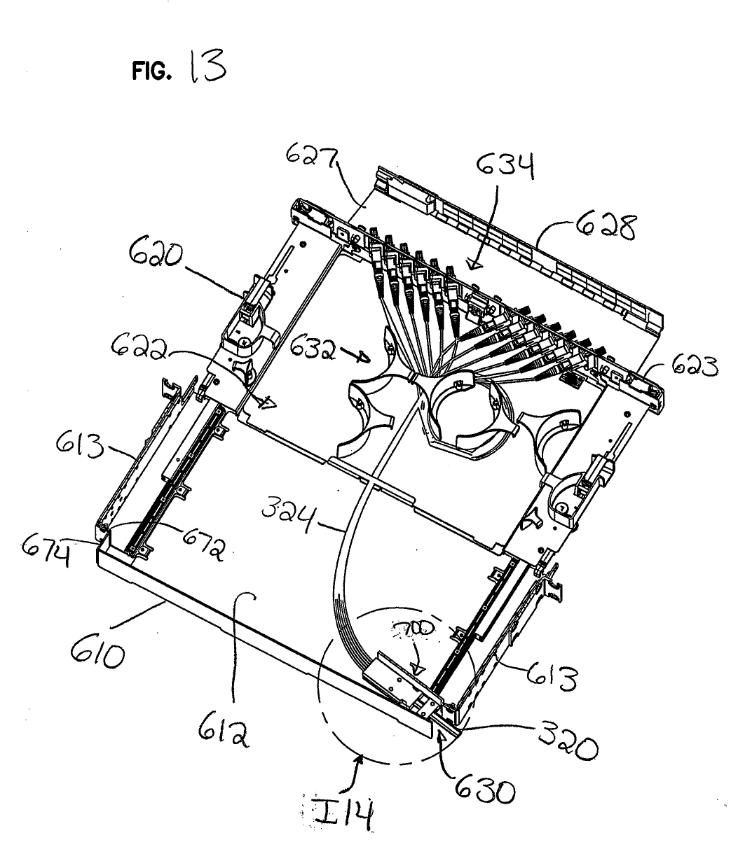

In the example shown, the fibers 324 are routed from the cable port 630, looped around the path R in the first management region 632, and plugged into the termination region 634. When the drawer 620 is closed within the chassis housing 610, the fibers 324 form a loop having a first diameter D1. Typically, the inner circumference of the loop is spaced from the inner partial spools 651, 652. When the drawer 620 is opened, the fiber loop constricts around the inner spools 651, 652 to accommodate the termination region 634 moving away from the fanout devices 750 at the cable port 630 (e.g., see FIG. 12). Accordingly, the diameter of the fiber loop shrinks from D1 (FIG. 10) to D2 (FIG. 12), where D2 is less than D1.

FIGS. 13-16 show on example attachment arrangement for mounting one or more fanout devices 750 to the chassis housing 610 at the cable port 630. The attachment arrangement includes a bracket 700 that is configured to mount to the chassis housing 610 at the cable port 630. In some implementations, the cable port 630 is defined as a separation between the rear wall 615 of the housing 610 and one of the side walls 613. In the example shown, such a separation is provided between the rear wall 615 and each side wall 613. Each side wall 613 also includes a flange 672 that extends inwardly substantially parallel to the rear wall 615.

A bracket 674 is configured to mount to the chassis housing 610 to cover the gap between the rear wall 615 and the respective side wall 613. For example, the bracket 674 can be fastened (e.g., screwed, bolted, etc.) to the flange 672 extending inwardly from the side wall 613. In one implementation, the bracket 674 is an L-shaped bracket. In other implementations, however, other shapes can be used.

To provide a cable port 630, the bracket 674 can be removed from the chassis housing 610 to expose the gap between the rear wall 615 and the respective side wall 613. A mounting bracket 700 is attached to the chassis housing 610 at the gap to position one or more fanout devices 750 at the cable port 630. An example mounting bracket 700 is shown in FIG. 16. The example mounting bracket 700 includes a mounting surface 705, a support surface 710, and an attachment flange 715. The attachment flange 715 attaches (e.g., screws, bolts, etc.) to the flange 672 extending inwardly from the respective side wall 613 of the chassis housing 610.

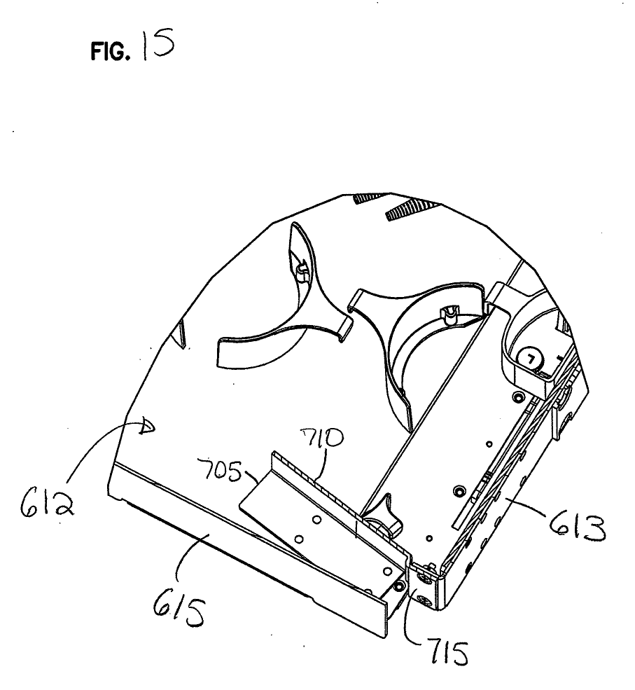

The mounting surface 705 defines openings 708 through which fasteners (e.g., screws, bolts, etc.) can extend to attach one or more fanout devices 750 to the mounting surface 705. The support surface 710 extends upwardly from the mounting surface 705 to form a generally L-shaped transverse cross-section. The mounting surface 705 also can define openings to accommodate attaching a clamp or other retaining structure 755 to the bracket 700 (e.g., see FIG. 14).

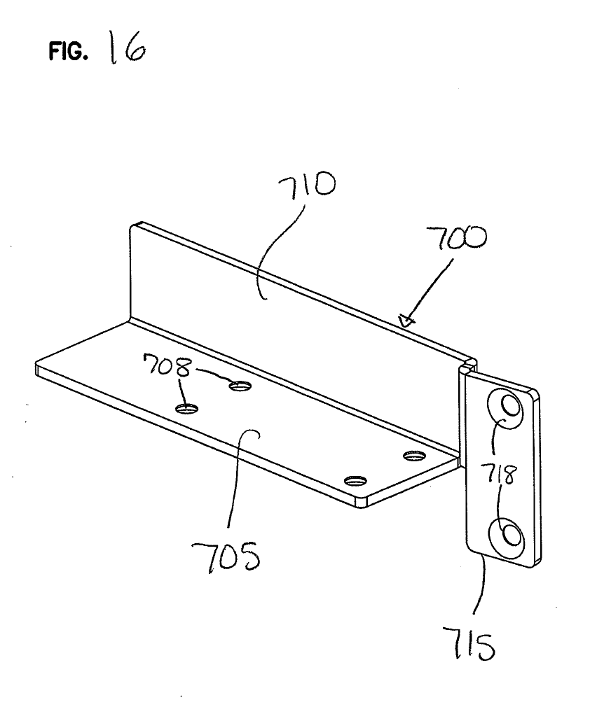

In the example shown, the mounting surface 705 and support surface 710 extend at an angle relative to the rear wall 615 of the chassis housing 610 when the bracket 700 is mounted to the chassis housing (see FIG. 15). Mounting the surfaces 705, 710 at such an angle facilitates routing of the fibers 324 without violating a bend radius limit of the fibers 324. In some implementations, the mounting and support surfaces 705, 710 are positioned at an angle ranging between 0 and 90 degrees relative to the rear wall 615. In other implementations, the mounting and support surfaces 705, 710 can be positioned at a greater angle.

The above specification, examples and data provide a complete description of the manufacture and use of the invention. Since many embodiments of the invention can be made without departing from the spirit and scope of the invention, the invention resides in the claims hereinafter appended.

1. A drawer panel comprising:
a chassis housing defining a first cable port;
a drawer mounted within the chassis housing, the drawer being configured to slide between an open position and a closed position;
a termination region positioned on the drawer, the termination region including a plurality of adapters; and
at least a first stub cable routed to the first cable port of the chassis housing, the first stub cable including a plurality of optical fibers, the optical fibers having first ends that are routed to the termination region and plugged into the adapters, the optical fibers having second ends that are terminated by a multi-fiber connector.

2. The drawer panel of claim 1, wherein the multi-fiber connector is a ruggedized multi-fiber connector.

3. The drawer panel of claim 1, wherein the drawer has an interior defining a first cable management region in which the optical fibers of the stub cable are managed.

4. The drawer panel of claim 3, wherein the first cable management region includes a plurality of management structures that form a routing path having an inner perimeter and an outer perimeter, wherein the optical fibers of the stub cable are looped within the routing path prior to being routed to the termination region.

5. The drawer panel of claim 4, wherein the inner perimeter of the cable routing path is sufficiently spaced from the outer perimeter to accommodate a fiber loop having a first diameter when the drawer is in the closed position and to accommodate a fiber loop having a second diameter when the drawer is in the open position, wherein the second diameter is less than the first diameter.

6. The drawer panel of claim 1, further comprising at least one fanout device mounted to the chassis housing at the first cable port, the fanout device being configured to separate the optical fibers of the stub cable.

7. The drawer panel of claim 6, wherein the chassis housing includes opposing side walls extending between opposing end walls to define an open front, wherein the chassis housing includes a rear wall opposing the open front, and wherein the first cable port is defined by a gap between the rear wall and one of the side walls.

8. The drawer panel of claim 7, further comprising a mounting bracket configured to attach to the chassis housing to cover the gap, wherein the mounting bracket includes a mounting surface and an attachment flange, wherein the fanout device is fastened to the mounting surface of the mounting bracket.

9. The drawer panel of claim 8, wherein the side wall includes an inwardly extending flange at the gap to which the attachment flange is configured to fasten.

10. The drawer panel of claim 8, wherein the mounting surface of the mounting bracket extends at an angle relative to the rear wall of the chassis housing when the bracket is attached to the chassis housing.

11. The drawer panel of claim 1, wherein the chassis housing is configured to mount to an equipment rack.

12. The drawer panel of claim 1, wherein the drawer includes a trough at the termination region, the trough being configured to manage second optical fibers that are plugged into the termination region to optically couple to the optical fibers of the stub cable.

13. The drawer panel of claim 1, wherein a second stub cable is routed to the chassis housing at which the second stub cable is separated into individual optical fibers, which are routed to the termination field.

14. The drawer panel of claim 13, wherein the second stub cable is routed to the first cable port.

15. The drawer panel of claim 13, wherein the chassis housing defines a second cable port to which the second stub cable is routed.
